(19) United States
(12) Patent Application Publication
(10) Pub. No.: US 2021/0056434 A1
(43) Pub. Date: Feb. 25, 2021

(54) MODEL TREE CLASSIFIER SYSTEM

(71) Applicant: SAP SE, Walldorf (DE)

(72) Inventor: Balaji Raghunathan, Bengaluru (IN)

(21) Appl. No.: 16/543,948

(22) Filed: Aug. 19, 2019

(51) Int. Cl. G06N 5/00; G06N 20/20; G06N 5/04

(52) U.S. Cl. CPC G06N 5/003; G06N 5/04; G06N 20/20

(57) ABSTRACT

Systems and methods are provided for analyzing input data using a first machine learning model corresponding to a root level node of a model tree classifier to generate a level node classification and a confidence score corresponding to the classification, and for each level in the hierarchy of nodes after the root level node in the model tree classifier, determining a next level node of the model tree classifier based on a generated classification output of a previous level node, and analyzing the input data to generate a level node classification output and a level node confidence score corresponding to the classification. The systems and methods further provide for generating a final classification for the input data based on alignment with a previous level node classification output and confidence scores corresponding to each level node classification output.

### BACKGROUND

A monolithic hierarchical model has been discussed for addressing use cases, such as image recognition, where a number of target labels can be significantly high (e.g., in the millions). Building a monolithic model, however, has some fundamental drawbacks. For example, it is inherently slow to train and also slow to classify a cluster or sequence of LSTMs and multi-layer neural nets. Moreover, there cannot be a realistic correlation between the neurons and the number of layers if needed to connect each layer to some level of classification in the taxonomy or hierarchy. Further, the sheer number of classification labels can make training algorithms and optimizers fail to converge despite having a significant number of good training examples.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIG. 2-4 each illustrates an example hierarchy, according to some example embodiments.

FIGS. 5A and 5B are flow charts illustrating aspects of a method for classification of input data, according to some example embodiments.

FIG. 6 is a block diagram illustrating an example of a software architecture that may be installed on a machine, according to some example embodiments.

FIG. 7 illustrates a diagrammatic representation of a machine, in the form of a computer system, within which a set of instructions may be executed for causing the machine to perform any one or more of the methodologies discussed herein, according to an example embodiment.

### DETAILED DESCRIPTION

Systems and methods described herein relate to a model tree classifier system. As explained above, a single monolithic machine learning model has a number of drawbacks. Example embodiments employ a hierarchy of machine learning models, instead of a single monolithic model, to classify items at each level of the hierarchy starting from a single model at the top root node and having a cluster of models at each level going down the hierarchy. Each machine learning model can have an algorithm of its own. For example, the root level machine learning model could be a Naive Bayes classifier, whereas a second level machine learning model could be a neural network (NN) or Convolutional NN (CNN). Other example machine learning models that can be used are RNN and LSTMs for one or more nodes in the model tree classifier. Thus, each machine learning model at each node of the model tree classifier can classify to one label and there exists a model at a next level with subcategories of a previous classification category. Moreover, example embodiments address error propagation within the model tree classifier system, as explained in further detail below.

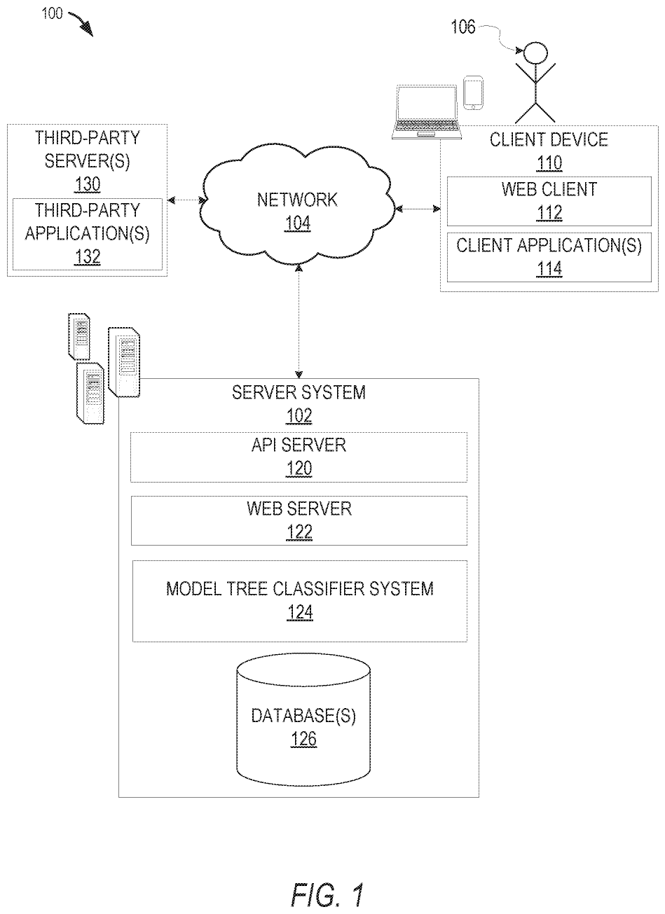

FIG. 1 is a block diagram illustrating a networked system 100, according to some example embodiments. The system 100 may include one or more client devices such as client device 110. The client device 110 may comprise, but is not limited to, a mobile phone, desktop computer, laptop, portable digital assistants (PDA), smart phone, tablet, ultrabook, netbook, laptop, multi-processor system, microprocessor-based or programmable consumer electronic, game console, set-top box, computer in a vehicle, or any other communication device that a user may utilize to access the networked system 100. In some embodiments, the client device 110 may comprise a display module (not shown) to display information (e.g., in the form of user interfaces). In further embodiments, the client device 110 may comprise one or more of touch screens, accelerometers, gyroscopes, cameras, microphones, global positioning system (GPS) devices, and so forth. The client device 110 may be a device of a user 106 that is used to access and a model tree classifier, among other applications.

One or more users 106 may be a person, a machine, or other means of interacting with the client device 110. In example embodiments, the user 106 may not be part of the system 100 but may interact with the system 100 via the client device 110 or other means. For instance, the user 106 may provide input (e.g., touch screen input or alphanumeric input) to the client device 110 and the input may be communicated to other entities in the system 100 (e.g., third-party servers 130, server system 102, etc.) via the network 104. In this instance, the other entities in the system 100, in response to receiving the input from the user 106, may communicate information to the client device 110 via the network 104 to be presented to the user 106. In this way, the user 106 may interact with the various entities in the system 100 using the client device 110.

The system 100 may further include a network 104. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

The client device 110 may access the various data and applications provided by other entities in the system 100 via web client 112 (e.g., a browser, such as the Internet Explorer® browser developed by Microsoft® Corporation of Redmond, Wash. State) or one or more client applications 114. The client device 110 may include one or more client applications 114 (also referred to as “apps”) such as, but not limited to, a web browser, a search engine, a messaging application, an electronic mail (email) application, an e-commerce site application, a mapping or location application, an enterprise resource planning (ERP) application, a customer relationship management (CRM) application, an analytics design application, a model classifier application, and the like.

In some embodiments, one or more client applications 114 may be included in a given client device 110, and configured to locally provide the user interface and at least some of the functionalities, with the client application(s) 114 configured to communicate with other entities in the system 100 (e.g., third-party servers 130, server system 102, etc.), on an as-needed basis, for data and/or processing capabilities not locally available (e.g., access location information, access a model tree classifier, to authenticate a user 106, to verify a method of payment). Conversely, one or more applications 114 may not be included in the client device 110, and then the client device 110 may use its web browser to access the one or more applications hosted on other entities in the system 100 (e.g., third-party servers 130, server system 102, etc.).

A server system 102 may provide server-side functionality via the network 104 (e.g., the Internet or wide area network (WAN)) to one or more third-party servers 130 and/or one or more client devices 110. The server system 102 may include an application program interface (API) server 120, a web server 122, and a model tree classifier system 124 that may be communicatively coupled with one or more databases 126.

The one or more databases 126 may be storage devices that store data related to users of the system 100, applications associated with the system 100, cloud services, and so forth. The one or more databases 126 may further store information related to third-party servers 130, third-party applications 132, client devices 110, client applications 114, users 106, and so forth. In one example, the one or more databases 126 may be cloud-based storage.

The server system 102 may be a cloud computing environment, according to some example embodiments. The server system 102, and any servers associated with the server system 102, may be associated with a cloud-based application, in one example embodiment.

The model tree classifier system 124 may provide back-end support for third-party applications 132 and client applications 114, which may include cloud-based applications. The model tree classifier system 124 processes and classifies input data, as described in further detail below. The model tree classifier system 124 may comprise one or more servers or other computing devices or systems.

The system 100 may further include one or more third-party servers 130. The one or more third-party servers 130 may include one or more third-party application(s) 132. The one or more third-party application(s) 132, executing on third-party server(s) 130, may interact with the server system 102 via API server 120 via a programmatic interface provided by the API server 120. For example, one or more the third-party applications 132 may request and utilize information from the server system 102 via the API server 120 to support one or more features or functions on a website hosted by the third party or an application hosted by the third party. The third-party website or application 132, for example, may provide classification services that are supported by relevant functionality and data in the server system 102.

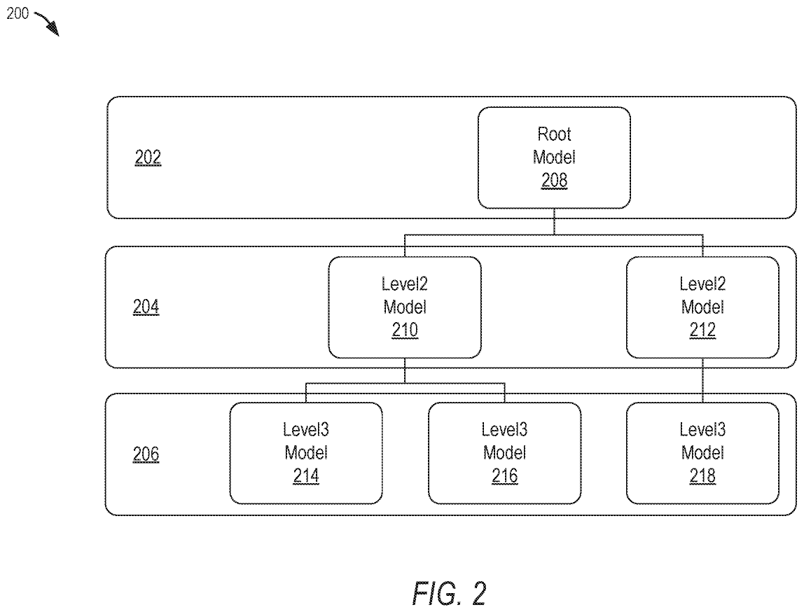

FIG. 2 illustrates an example hierarchy 200 of machine learning models in a model tree classifier system 124. The example hierarchy 200 is directed to an image recognition scenario. The example hierarchy 200 comprises three levels. A first level is a root level 202 that comprises one node corresponding to a root level machine learning model 208. In one example, the root level machine learning model 208 classifies an image (e.g., photograph) into classes or categories, such as vehicles, animals, plants/trees, electronics, scenic picture (e.g., mountains and rivers), and so forth.

In the example hierarchy 200, a second level 204 comprises two nodes corresponding to level two machine learning models 210 and 212. As mentioned above, the level two machine learning models 210 and 212 can each comprise a different type of machine learning model than the root level machine learning model 208 and/or a different type of machine learning model than each other. In one example, the level two machine learning models 210 and 212 can each classify an image into classes or categories (e.g., subclass or subcategories of the root level categories), such as car, truck, bike, mammals, birds, fish, wild animals, domestic animals, a number of species of birds, different types of fish, computers, servers, compact devices, phone sets, and so forth. In one example, each node in the second level 204 categorizes the image into specified subcategories. For example, the level two machine learning model 210 may comprise the subcategory for vehicles and electronics. Thus, if an image is categorized (e.g., classified) as a vehicle at the root level machine learning model 208, the level two machine learning model 210 will then analyze the image to classify the image as a car, truck, van, bus, bike, or the like. Likewise, if an image is classified as electronics at the root level machine learning model 208, the level two machine learning model 210 will then analyze the image to classify the image as a computer, server, compact device, phone set, or the like. The machine learning model 212 may comprise the subcategory for animals. Thus, if an image is categorized (e.g., classified) as an animal at the root level machine learning model 208, the level two machine learning model 212 will then analyze the image to classify the image as a mammal, bird, fish, wild animal, domestic animal, or the like.

In the example hierarchy 200, a third level 206 comprises three nodes corresponding to level three machine learning models 214, 216, and 218. As mentioned above, the level three machine learning models 214, 216, and 218 can each comprise a different type of machine learning model than the machine learning models at other levels and/or a different type of machine learning model than each other. In one example, the level three machine learning models 214, 216, and 218 classify an image into classes or categories (e.g., subclass or subcategories of the second level categories), such as SUV, hatchback, sedan, feline, canine, elephant, horses, ostrich, crow, tablet, iPad, phone, and so forth. As shown in FIG. 2, the level three machine learning models 214 and 216 are subcategories of the level two machine learning model 210 and the level three machine learning model 218 is a subcategory of the level two machine learning model 212.

In this way, each level has narrower categories and is more granular. A machine learning model at each level has the same input (e.g., the image) and outputs a classification and a confidence score, as explained in further detail below.

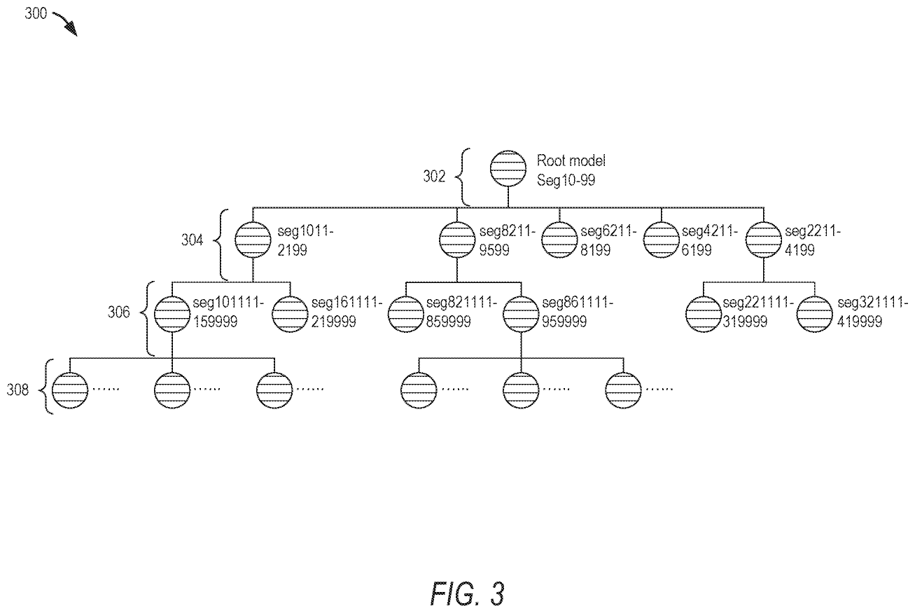

FIG. 3 illustrates another example hierarchy 300 in a model tree classifier system 124. The example hierarchy 300 is directed to a spend visibility scenario to categorize invoices and related documentation and images for spend analytics. For example, an organization may want to analyze its quarterly spend in different categories of items (e.g., types of equipment, types of services). In the example hierarchy 300, the nodes of the hierarchy are organized according to a United Nations Standard Products and Services Code (UNSPSC) based classification taxonomy to analyze spend items. A UNSPSC is a four-level hierarchy coded as an eight-digit number, with an optional fifth level adding two more digits. Accordingly, the example hierarchy 300 comprises four levels including a root level 302, a second level 304, a third level 306, and a fourth level 308.

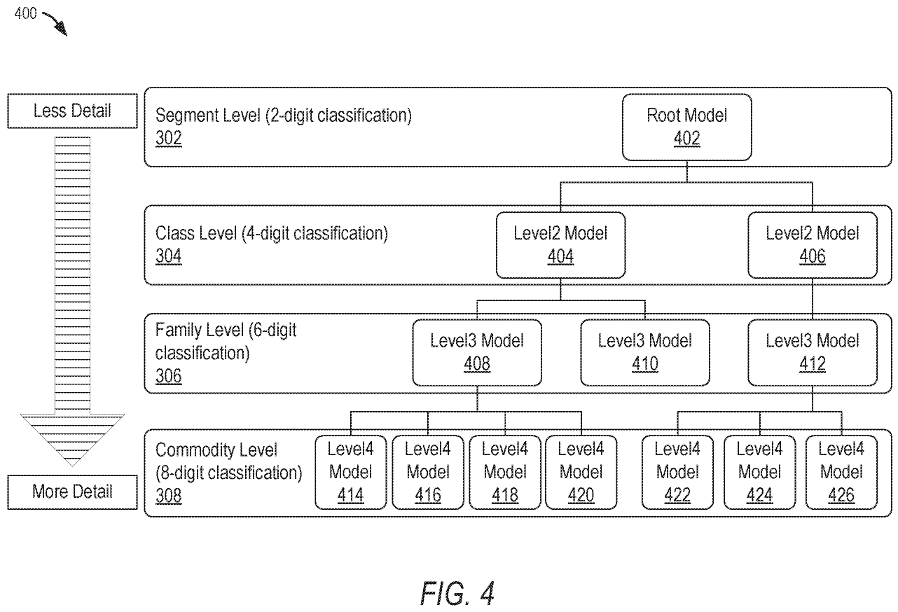

FIG. 4 illustrates further details of the example hierarchy 300. For example, FIG. 4 shows that the root level 302 comprises a root model 402 at a segment level (e.g., 2-digit classification), the second level 304 comprises level two models 404 and 406 at a class level (e.g., 4-digit classification), the third level 306 comprises three models 408, 410, and 412 at a family level (e.g., 6-digit classification), and the fourth level 308 comprises seven models 414, 416, 418, 420, 422, 424, and 426 at a commodity level (e.g., 8-digit classification). In this way the model classifies from less detail to more detail as the model tree classifier hierarchy is traversed. For example, the root model could classify an item “Front end loader” to segment 22 (e.g., building construction and machinery and accessories), the corresponding second level model can classify the item to subcategory 2210 (e.g., heaving construction machinery and equipment), the corresponding third level model can classify the item to 221015 (each moving machinery) and the corresponding fourth level model can classify the item to 22101502 (e.g., front end loaders). In this example, a model is built for a range of segments, for example 10-21, 21-31, 31-41, 41-51, 51-71, 71-91, and 91-95 at the second level 304.

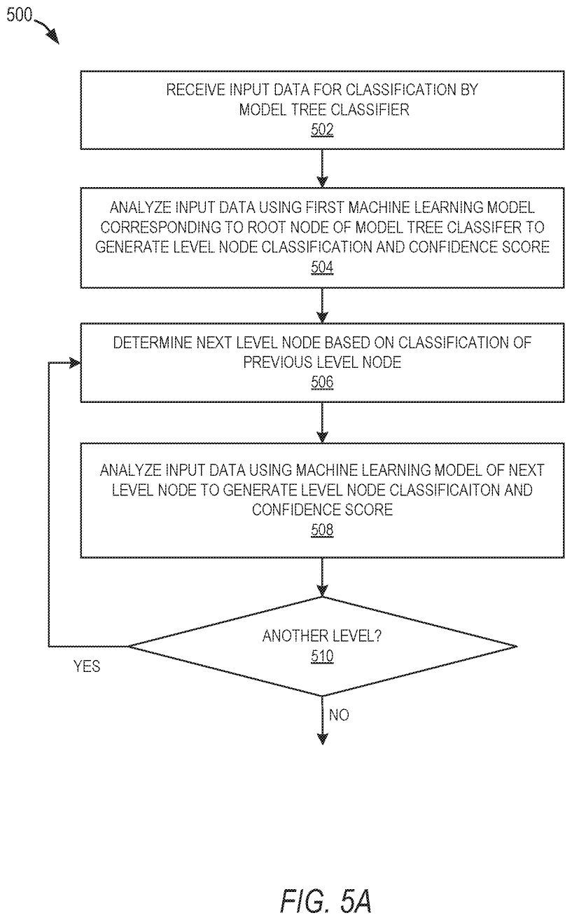

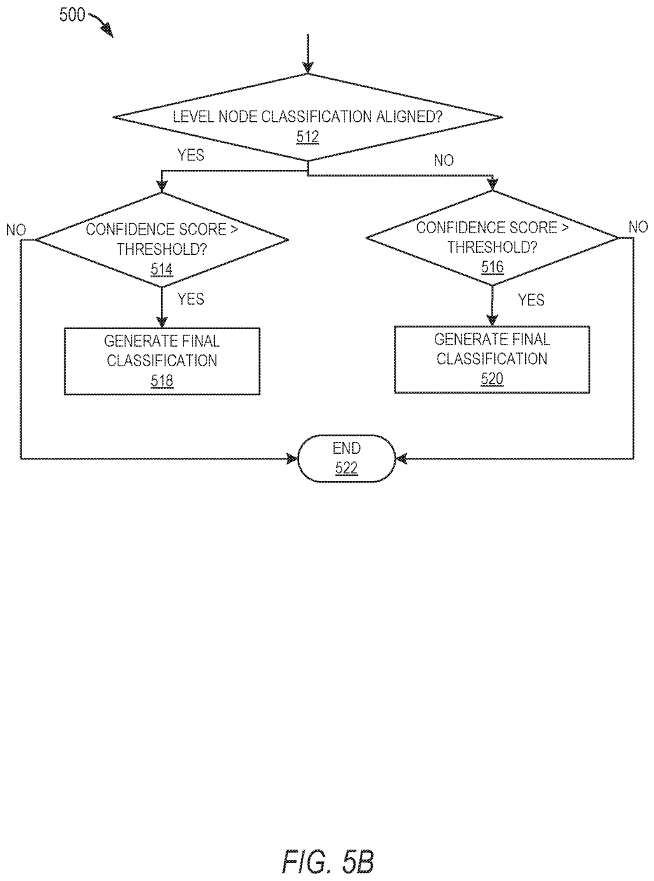

FIGS. 5A and 5B comprise a flow chart (split into two figures for readability) illustrating aspects of a method 500 for classifying input date, according to some example embodiments. For illustrative purposes, method 500 is described with respect to the networked system 100 of FIG. 1. It is to be understood that method 500 may be practiced with other system configurations in other embodiments.

In operation 502, a computing system (e.g., server system 102 or model tree classifier system 124) receives input data for classification by a model tree classifier comprising a machine learning model corresponding to each level in a hierarchy of nodes in the model tree classifier. For example, the computing system can receive input data (e.g., an image, a document, text, video, audio) for classification from a computing device (e.g., client device 110) or other system (e.g., third-party server 130) and a request for classification of the input data. In another example, the computing system accesses one or more datastores (e.g., databases 126) to retrieve input data to be classified.

The model tree classifier can comprise a hierarchy of nodes. As explained above, the hierarchy can comprise a number of nodes at each level of the hierarchy and each node can correspond to a different machine learning model. The machine learning models can be different for each level, for each node, or for multiple levels. For example, a machine learning model of a root level node can be a different type of machine learning model than a machine learning model at a node in a second or third level of the model tree classifier. In one example, the machine learning model of a higher node, such as the root node, is a less processing-intense machine learning model that generates a less precise classification (e.g., since the classification is at a broader level), and a machine learning model at a next level (e.g., a second, third, fourth) is a more processing-intense model and generates a more precise classification (e.g., since the classification is at a narrower level).

In operation 504, the computing system analyzes the input data using a first machine learning model corresponding to a root level node of the model tree classifier to generate a level node classification and confidence score corresponding to the classification. Using the image recognition example of FIG. 2, the machine learning model 208 of the root level node may output a classification of animal for an image (e.g., the input data) and a confidence score of 0.8 (e.g., 80%). The confidence score represents the probability that the classification (e.g., of an animal) is correct or accurate.

In operation 506, the computing system determines a next level node based on classification of the previous level node. For example, the computing system determines which node in the next level is a subcategory of the classification (e.g., category) output by the previous node. Using the example above of FIG. 2, the computing system determines that the node for the subcategory “animal” is the node corresponding to level two machine learning model 210.

In operation 508, the computing system analyzes the input data using the machine learning model of the next level node to generate a level node classification and confidence score for the next level. Returning to the example of FIG. 2, the computing system uses the level two machine learning model 210 to output a classification of a cow for the image (e.g., input data) and a confidence score of 0.5.

In operation 510, the computing system determines whether there is another level in the hierarchy of the model tree classifier. If yes, the computing system returns to operation 506 to determine the next level node based on the classification of the previous level node. If no, the classification process is complete and the computing system analyzes the result classifications for validation and error correction.

One technical issue in a hierarchical machine learning model is that a result can become misaligned while different paths of the hierarchy of the model tree classifier are traversed. For example, a first or root level classifies the input data (e.g., image of a cow) as a mammal. The child node in a second level corresponding to a subcategory for mammal (e.g., domestic and wild animals) classifies the input data as a domestic animal. A third level should then classify the input data among domestic animals (e.g., bovine); however, if the third level classifies the input data as a lion, the results become misaligned since a lion is not a domestic animal. One simple way to address this issue is to stop at the level that had alignment, in this example domestic animal. This method, however, is not as accurate since it could result in a very high level categorization of the input data. Example embodiments use both alignment and confidence score at each level to determine the final classification output, as explained via operations 512-522 of FIG. 5B.

In operation 512, the computing system determines whether each level node classification output is aligned with a previous level node classification output, at operation 512. For example, the computing system analyzes the output classification at each level to determine whether each level output classification falls within the same category as the classification output of the previous category. Using the example above, a domestic animal is a subcategory of a mammal, and so there is alignment at a second level, but a lion is not a domestic animal, so there is not alignment at the third level.

If the level node classification is aligned (yes for operation 512), the computing system determines whether a confidence score corresponding to at least one level node classification output is greater than a specified threshold at operation 514. For example, the specified threshold may be 0.9 (90%) and thus, the computing system determines whether a confidence score for any of the levels is greater than 0.9. If none of the confidences scores are greater than 0.9, the process ends at operation 522. For example, if a confidence score is 0.33 at a root level, 0.30 at a second level, and 0.5 at a third level, none of the confidence scores are greater than the specified threshold of 0.9, and thus no final classification is provided for the input data, even though there is alignment between the levels of categories.

If at least one confidence score is greater than 0.9, then the process continues to generate a final classification at operation 518. For example, if a root level confidence score is 0.85, a second level confidence score is 0.95, and a third level confidence is 0.7, at least one of the confidences scores is greater than 0.9 and thus, a final classification is generated. The final classification comprises the level node classification output of the last level node in the hierarchy of nodes in the model tree classifier. For example, if there are four levels in the hierarchy of nodes in the model tree classifier, the final classification is the classification output of a node in the fourth level.

Returning to operation 512, if the level node classifications are not aligned (no), a final output may still be generated if the confidence score of the levels that were aligned is greater than the specified threshold (e.g., 0.9). In operation 516, the computing system determines whether any confidence score of the levels that are aligned are over the specified threshold. For example, if a first root level (e.g., animal) and second level (e.g., domestic animal) are aligned but not a third level (e.g., lion), the computing system analyzes the confidence scores for the first level and second levels, and if none of those is greater than the specified threshold, the process ends at operation 522. For example, if a confidence score is 0.33 at the root level, 0.30 at the second level, no final classification is provided for the input data.

If at least one of the confidence scores of the levels that are aligned is greater than the specified threshold, the computing system generates a final classification at operation 520. The final classification comprises the classification of the last aligned level. Using the example above, the classification of domestic animal would be used as the final classification.

In one example embodiment, the computing system may also take into consideration the number of levels that are aligned, in the case where there is misalignment in one or more levels (e.g., no at operation 512), even though a confidence score is greater than a threshold confidence score. For example, there may be a specified threshold number of levels (e.g., 2 or 3) that need to be aligned to generate a final classification. If the number of levels that are aligned is less than the specified threshold number of levels, the process ends at 522 and no final classification is provided for the input data, even if a confidence score is greater than a specified threshold confidence score. If the number of levels that are aligned is equal to or greater than the specified threshold number of levels, then a final classification is generated at 520. The final classification comprises the classification of the last aligned level, as explained above.

In one example embodiment, the computing system may still generate a final classification even if the number of levels is less than a specified threshold number of levels if at least one confidence score is greater than a second higher specified threshold (e.g., 0.95). In this scenario, even if there is misalignment in at least one level and the number of levels that are aligned is less than a specified threshold number of levels, the computing system generates a final classification for the input data. The final classification comprises the classification of the last aligned level, as explained above.

In one example embodiment, a confidence score can be weighted depending on the type of machine learning model that output the classification and corresponding confidence score. For instance, some machine learning model algorithms can be more strict while others can be less strict. A stricter algorithm may be given more weight than a looser algorithm. For example, a confidence score of 0.7 from a stricter algorithm can be the equivalent to a confidence score of 0.9 of a looser algorithm.

In one example embodiment, operations 510 and 512 are combined such that the computing system checks for alignment at each level node classification (e.g., operation 512 at each level node). If the classification is aligned, the computing system checks to see if there are any further levels (e.g., operation 510), if the classification is misaligned, the computing system performs the confidence scoring described above (e.g., operations 516 and 520) to determine whether to generate a final classification.

Example embodiments provide for a number of advantages. For example, one advantage of having the hierarchy described herein is scalability. Using example embodiments, a system can classify a given example from one among a billion categories provided a well-balanced model tree. In one example, the classification progresses along one unambiguous path from the root node to a detailed node.

In another example, the same structure can be utilized for multi-class classification where a given example can be classified into more than one label and then consolidated. For instance, an image of a lion hunting a deer could be classified as two or more different labels and then the system consolidates the labels to conclude that the image is related to “hunting.”

In another example, the described model tree facilitates distributed computing since the models in the different nodes of the hierarchy can be trained in a distributed fashion (on a kubernetes cluster, as an example), as well as the classification/inference. This facilitates faster engineering, production readiness, and operationalization.

The following examples describe various embodiments of methods, machine-readable media, and systems (e.g., machines, devices, or other apparatus) discussed herein.

Example 1. A computer-implemented method comprising:

receiving, at a server system, input data for classification by a model tree classifier comprising a machine learning model corresponding to each level in a hierarchy of nodes in the model tree classifier;

analyzing the input data using a first machine learning model corresponding to a root level node of the model tree classifier to generate a level node classification and a confidence score corresponding to the classification;

for each level in the hierarchy of nodes after the root level node in the model tree classifier:
determining a next level node of the model tree classifier based on a generated classification output of a previous level node; and
analyzing the input data to generate a level node classification output and a level node confidence score corresponding to the classification;

determining whether each level node classification output is aligned with a previous level node classification output;

based on determining that each level node classification output is aligned with a previous level node classification output, determining whether a confidence score corresponding to at least one level node classification output is greater than a specified threshold; and

generating a final classification for the input data based on determining that a confidence score corresponding to the at least one level node classification output is greater than the specified threshold, the final classification comprising the level node classification output of the last level node in the hierarchy of nodes in the model tree classifier.

Example 2. A method according to any of the previous examples, further comprising:

based on determining that each level node classification output is not aligned with a previous level node classification output based on determining at first level node classification is not aligned with a previous second level node classification, generating the final classification for the input data based on determining that a confidence score corresponding to the at least one level node classification output is greater than the specified threshold, the final classification comprising the previous second level node classification.

Example 3. A method according to any of the previous examples, further comprising:

not generating the final classification based on determining that there is no confidence score corresponding to a level node classification that is greater than the specified threshold.

Example 4. A method according to any of the previous examples, further comprising:

determining that a number of levels of nodes that are aligned are less than a specified threshold number of levels; and

not generating the final classification based on the determination that the number of levels of nodes that are aligned is less than the specified threshold number of levels.

Example 5. A method according to any of the previous examples, further comprising:

based on determining that each level node classification output is not aligned with a previous level node classification output based on determining at first level node classification is not aligned with a previous second level node classification, determining that a number of levels of nodes that are aligned is less than a specified threshold number of levels; and

based on determining that a confidence score is greater than a higher specified threshold, generating the final classification for the input data, the final classification comprising the previous second level node classification.

Example 6. A method according to any of the previous examples, wherein the input data is at least one of an image, a document, text, video, or audio.
Example 7. A method according to any of the previous examples, wherein the first machine learning model is a different type of machine learning model than the machine learning model corresponding to a next level node of the model tree classifier.
Example 8. A method according to any of the previous examples, wherein the first machine learning model is a less processing-intense machine learning model and generates a less precise classification and the machine learning model corresponding to a next level node of the model tree classifier is a more processing-intense machine learning model and generates a more precise classification.
Example 9. A system comprising:

a memory that stores instructions; and

one or more processors configured by the instructions to perform operations comprising:
receiving input data for classification by a model tree classifier comprising a machine learning model corresponding to each level in a hierarchy of nodes in the model tree classifier;
analyzing the input data using a first machine learning model corresponding to a root level node of the model tree classifier to generate a level node classification and a confidence score corresponding to the classification;
for each level in the hierarchy of nodes after the root level node in the model tree classifier:
   determining a next level node of the model tree classifier based on a generated classification output of a previous level node; and
   analyzing the input data to generate a level node classification output and a level node confidence score corresponding to the classification;

determining whether each level node classification output is aligned with a previous level node classification output;

based on determining that each level node classification output is aligned with a previous level node classification output, determining whether a confidence score corresponding to at least one level node classification output is greater than a specified threshold; and

generating a final classification for the input data based on determining that a confidence score corresponding to the at least one level node classification output is greater than the specified threshold, the final classification comprising the level node classification output of the last level node in the hierarchy of nodes in the model tree classifier.

Example 10. A system according to any of the previous examples, the operations further comprising:
based on determining that each level node classification output is not aligned with a previous level node classification output based on determining at first level node classification is not aligned with a previous second level node classification, generating the final classification for the input data based on determining that a confidence score corresponding to the at least one level node classification output is greater than the specified threshold, the final classification comprising the previous second level node classification.
   Example 11. A system according to any of the previous examples, the operations further comprising:

not generating the final classification based on determining that there is no confidence score corresponding to a level node classification that is greater than the specified threshold.

Example 12. A system according to any of the previous examples, the operations further comprising:

determining that a number of levels of nodes that are aligned is less than a specified threshold number of levels; and

not generating the final classification based on the determination that the number of levels of nodes that are aligned is less than the specified threshold number of levels.

Example 13. A system according to any of the previous examples, the operations further comprising:
based on determining that each level node classification output is not aligned with a previous level node classification output based on determining at first level node classification is not aligned with a previous second level node classification, determining that a number of levels of nodes that are aligned is less than a specified threshold number of levels; and

based on determining that a confidence score is greater than a higher specified threshold, generating the final classification for the input data, the final classification comprising the previous second level node classification.

Example 14. A system according to any of the previous examples, wherein the input data is at least one of an image, a document, text, video, or audio.
Example 15. A system according to any of the previous examples, wherein the first machine learning model is a different type of machine learning model than the machine learning model corresponding to a next level node of the model tree classifier.
Example 16. A system according to any of the previous examples, wherein the first machine learning model is a less processing-intense machine learning model and generates a less precise classification and the machine learning model corresponding to a next level node of the model tree classifier is a more processing-intense machine learning model and generates a more precise classification.
Example 17. A non-transitory computer-readable medium comprising instructions stored thereon that are executable by at least one processor to cause a computing device to perform operations comprising:

receiving input data for classification by a model tree classifier comprising a machine learning model corresponding to each level in a hierarchy of nodes in the model tree classifier;

analyzing the input data using a first machine learning model corresponding to a root level node of the model tree classifier to generate a level node classification and a confidence score corresponding to the classification;

for each level in the hierarchy of nodes after the root level node in the model tree classifier:
determining a next level node of the model tree classifier based on a generated classification output of a previous level node; and
analyzing the input data to generate a level node classification output and a level node confidence score corresponding to the classification;

determining whether each level node classification output is aligned with a previous level node classification output;

based on determining that each level node classification output is aligned with a previous level node classification output, determining whether a confidence score corresponding to at least one level node classification output is greater than a specified threshold; and

generating a final classification for the input data based on determining that a confidence score corresponding to the at least one level node classification output is greater than the specified threshold, the final classification comprising the level node classification output of the last level node in the hierarchy of nodes in the model tree classifier.

Example 18. A non-transitory computer-readable medium according to any of the previous examples, the operations further comprising:

based on determining that each level node classification output is not aligned with a previous level node classification output based on determining at first level node classification is not aligned with a previous second level node classification, generating the final classification for the input data based on determining that a confidence score corresponding to the at least one level node classification output is greater than the specified threshold, the final classification comprising the previous second level node classification.

Example 19. A non-transitory computer-readable medium according to any of the previous examples, the operations further comprising:

not generating the final classification based on determining that there is no confidence score corresponding to a level node classification that is greater than the specified threshold.

Example 20. A non-transitory computer-readable medium according to any of the previous examples, the operations further comprising:

determining that a number of levels of nodes that are aligned is less than a specified threshold number of levels; and

not generating the final classification based on the determination that the number of levels of nodes that are aligned is less than the specified threshold number of levels.

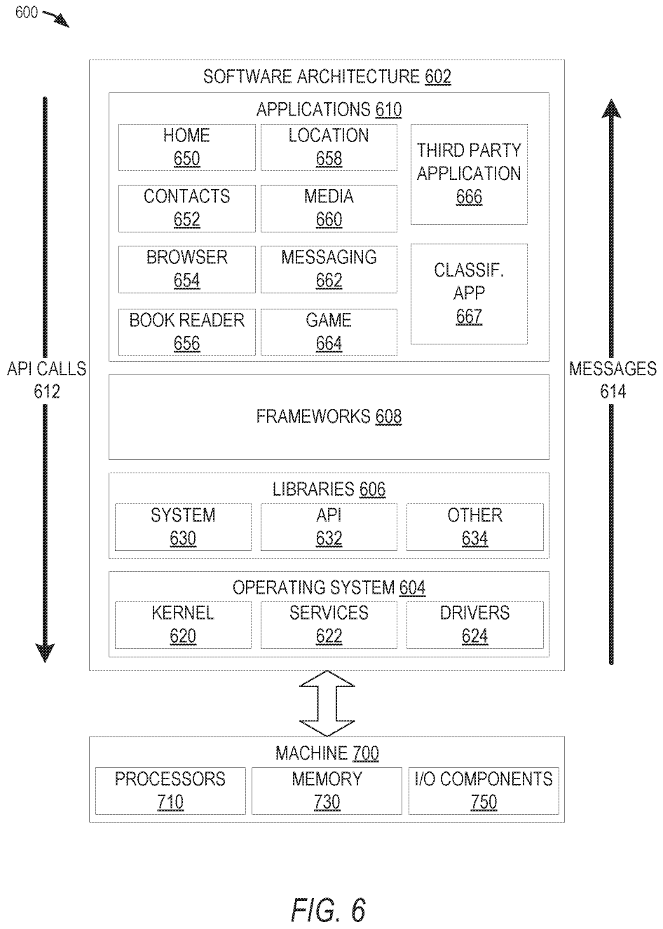

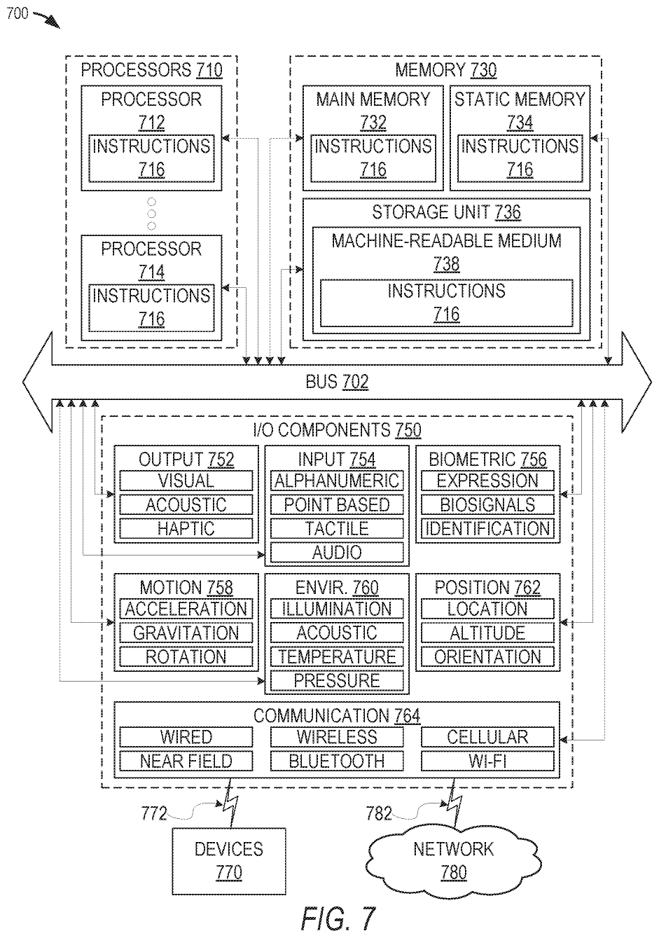

FIG. 6 is a block diagram 600 illustrating software architecture 602, which can be installed on any one or more of the devices described above. For example, in various embodiments, client devices 110 and servers and systems 130, 102, 120, 122, and 124 may be implemented using some or all of the elements of software architecture 602. FIG. 6 is merely a non-limiting example of a software architecture, and it will be appreciated that many other architectures can be implemented to facilitate the functionality described herein. In various embodiments, the software architecture 602 is implemented by hardware such as machine 700 of FIG. 7 that includes processors 710, memory 730, and I/O components 750. In this example, the software architecture 602 can be conceptualized as a stack of layers where each layer may provide a particular functionality. For example, the software architecture 602 includes layers such as an operating system 604, libraries 606, frameworks 608, and applications 610. Operationally, the applications 610 invoke application programming interface (API) calls 612 through the software stack and receive messages 614 in response to the API calls 612, consistent with some embodiments.

In various implementations, the operating system 604 manages hardware resources and provides common services. The operating system 604 includes, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionality. The services 622 can provide other common services for the other software layers. The drivers 624 are responsible for controlling or interfacing with the underlying hardware, according to some embodiments. For instance, the drivers 624 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and in three dimensions (3D) graphic content on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610, according to some embodiments. For example, the frameworks 608 provide various graphic user interface (GUI) functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications such as a third-party application 666. According to some embodiments, the applications 610 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 612 provided by the operating system 604 to facilitate functionality described herein.

Some embodiments may particularly include a classification application 667. In certain embodiments, this may be a stand-alone application that operates to manage communications with a server system such as third-party servers 130 or server system 102. In other embodiments, this functionality may be integrated with another application. The classification application 667 may request and display various data related to processing log files and may provide the capability for a user 106 to input data related to the objects via a touch interface, keyboard, or using a camera device of machine 700, communication with a server system via I/O components 750, and receipt and storage of object data in memory 730. Presentation of information and user inputs associated with the information may be managed by classification application 667 using different frameworks 608, library 606 elements, or operating system 604 elements operating on a machine 700.

FIG. 7 is a block diagram illustrating components of a machine 700, according to some embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application 610, an applet, an app, or other executable code) for causing the machine 700 to perform any one or more of the methodologies discussed herein can be executed. In alternative embodiments, the machine 700 operates as a standalone device or can be coupled (e.g., networked) to other machines. In a networked deployment, the machine 700 may operate in the capacity of a server machine 130, 102, 120, 122, 124, etc., or a client device 110 in a server-client network environment, or as a peer machine in a peer-to-peer (or distributed) network environment. The machine 700 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

In various embodiments, the machine 700 comprises processors 710, memory 730, and I/O components 750, which can be configured to communicate with each other via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 712 and a processor 714 that may execute the instructions 716. The term “processor” is intended to include multi-core processors 710 that may comprise two or more independent processors 712, 714 (also referred to as “cores”) that can execute instructions 716 contemporaneously. Although FIG. 7 shows multiple processors 710, the machine 700 may include a single processor 710 with a single core, a single processor 710 with multiple cores (e.g., a multi-core processor 710), multiple processors 712, 714 with a single core, multiple processors 712, 714 with multiples cores, or any combination thereof.

The memory 730 comprises a main memory 732, a static memory 734, and a storage unit 736 accessible to the processors 710 via the bus 702, according to some embodiments. The storage unit 736 can include a machine-readable medium 738 on which are stored the instructions 716 embodying any one or more of the methodologies or functions described herein. The instructions 716 can also reside, completely or at least partially, within the main memory 732, within the static memory 734, within at least one of the processors 710 (e.g., within the processor's cache memory), or any suitable combination thereof, during execution thereof by the machine 700. Accordingly, in various embodiments, the main memory 732, the static memory 734, and the processors 710 are considered machine-readable media 738.

As used herein, the term “memory” refers to a machine-readable medium 738 able to store data temporarily or permanently and may be taken to include, but not be limited to, random-access memory (RAM), read-only memory (ROM), buffer memory, flash memory, and cache memory. While the machine-readable medium 738 is shown, in an example embodiment, to be a single medium, the term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions 716, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 750 include a wide variety of components to receive input, provide output, produce output, transmit information, exchange information, capture measurements, and so on. In general, it will be appreciated that the I/O components 750 can include many other components that are not shown in FIG. 7. The I/O components 750 are grouped according to functionality merely for simplifying the following discussion, and the grouping is in no way limiting. In various example embodiments, the I/O components 750 include output components 752 and input components 754. The output components 752 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 754 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 750 include biometric components 756, motion components 758, environmental components 760, or position components 762, among a wide array of other components. For example, the biometric components 756 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 include acceleration sensor components (e.g., accelerometer), gravitation sensor components, rotation sensor components (e.g., gyroscope), and so forth. The environmental components 760 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 762 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 750 may include communication components 764 operable to couple the machine 700 to a network 780 or devices 770 via a coupling 782 and a coupling 772, respectively. For example, the communication components 764 include a network interface component or another suitable device to interface with the network 780. In further examples, communication components 764 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 770 may be another machine 700 or any of a wide variety of peripheral devices (e.g., a peripheral device coupled via a Universal Serial Bus (USB)).

Moreover, in some embodiments, the communication components 764 detect identifiers or include components operable to detect identifiers. For example, the communication components 764 include radio frequency identification (RFID) tag reader components, NFC smart tag detection components, optical reader components (e.g., an optical sensor to detect a one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 764, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 780 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 716 are transmitted or received over the network 780 using a transmission medium via a network interface device (e.g., a network interface component included in the communication components 764) and utilizing any one of a number of well-known transfer protocols (e.g., Hypertext Transfer Protocol (HTTP)). Similarly, in other example embodiments, the instructions 716 are transmitted or received using a transmission medium via the coupling 772 (e.g., a peer-to-peer coupling) to the devices 770. The term “transmission medium” shall be taken to include any intangible medium that is capable of storing, encoding, or carrying the instructions 716 for execution by the machine 700, and includes digital or analog communications signals or other intangible media to facilitate communication of such software.

Furthermore, the machine-readable medium 738 is non-transitory (in other words, not having any transitory signals) in that it does not embody a propagating signal. However, labeling the machine-readable medium 738 “non-transitory” should not be construed to mean that the medium is incapable of movement; the medium 738 should be considered as being transportable from one physical location to another. Additionally, since the machine-readable medium 738 is tangible, the medium 738 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
receiving, at a server system, input data for classification by a model tree classifier comprising a machine learning model corresponding to each level in a hierarchy of nodes in the model tree classifier;
analyzing the input data using a first machine learning model corresponding to a root level node of the model tree classifier to generate a level node classification and a confidence score corresponding to the classification;
for each level in the hierarchy of nodes after the root level node in the model tree classifier:
determining a next level node of the model tree classifier based on a generated classification output of a previous level node; and
analyzing the input data to generate a level node classification output and a level node confidence score corresponding to the classification;
determining whether each level node classification output is aligned with a previous level node classification output;
based on determining that each level node classification output is aligned with a previous level node classification output, determining whether a confidence score corresponding to at least one level node classification output is greater than a specified threshold; and
generating a final classification for the input data based on determining that a confidence score corresponding to the at least one level node classification output is greater than the specified threshold, the final classification comprising the level node classification output of the last level node in the hierarchy of nodes in the model tree classifier.

2. The method of claim 1, further comprising:
based on determining that each level node classification output is not aligned with a previous level node classification output based on determining at first level node classification is not aligned with a previous second level node classification, generating the final classification for the input data based on determining that a confidence score corresponding to the at least one level node classification output is greater than the specified threshold, the final classification comprising the previous second level node classification.

3. The method of claim 1, further comprising:
not generating the final classification based on determining that there is no confidence score corresponding to a level node classification that is greater than the specified threshold.

4. The method of claim 1, further comprising:
determining that a number of levels of nodes that are aligned are less than a specified threshold number of levels; and
not generating the final classification based on the determination that the number of levels of nodes that are aligned is less than the specified threshold number of levels.

5. The method of claim 1, further comprising:
based on determining that each level node classification output is not aligned with a previous level node classification output based on determining at first level node classification is not aligned with a previous second level node classification, determining that a number of levels of nodes that are aligned is less than a specified threshold number of levels; and
based on determining that a confidence score is greater than a higher specified threshold, generating the final classification for the input data, the final classification comprising the previous second level node classification.

6. The method of claim 1, wherein the input data is at least one of an image, a document, text, video, or audio.

7. The method of claim 1, wherein the first machine learning model is a different type of machine learning model than the machine learning model corresponding to a next level node of the model tree classifier.

8. The method of claim 7, wherein the first machine learning model is a less processing-intense machine learning model and generates a less precise classification and the machine learning model corresponding to a next level node of the model tree classifier is a more processing-intense machine learning model and generates a more precise classification.

9. A system comprising:
a memory that stores instructions; and
one or more processors configured by the instructions to perform operations comprising:
receiving input data for classification by a model tree classifier comprising a machine learning model corresponding to each level in a hierarchy of nodes in the model tree classifier;
analyzing the input data using a first machine learning model corresponding to a root level node of the model tree classifier to generate a level node classification and a confidence score corresponding to the classification;
for each level in the hierarchy of nodes after the root level node in the model tree classifier:
determining a next level node of the model tree classifier based on a generated classification output of a previous level node; and
analyzing the input data to generate a level node classification output and a level node confidence score corresponding to the classification;
determining whether each level node classification output is aligned with a previous level node classification output;
based on determining that each level node classification output is aligned with a previous level node classification output, determining whether a confidence score corresponding to at least one level node classification output is greater than a specified threshold; and
generating a final classification for the input data based on determining that a confidence score corresponding to the at least one level node classification output is greater than the specified threshold, the final classification comprising the level node classification output of the last level node in the hierarchy of nodes in the model tree classifier.

10. The system of claim 9, the operations further comprising:
based on determining that each level node classification output is not aligned with a previous level node classification output based on determining at first level node classification is not aligned with a previous second level node classification, generating the final classification for the input data based on determining that a confidence score corresponding to the at least one level node classification output is greater than the specified threshold, the final classification comprising the previous second level node classification.

11. The system of claim 9, the operations further comprising:
not generating the final classification based on determining that there is no confidence score corresponding to a level node classification that is greater than the specified threshold.

12. The system of claim 9, the operations further comprising:
determining that a number of levels of nodes that are aligned is less than a specified threshold number of levels; and
not generating the final classification based on the determination that the number of levels of nodes that are aligned is less than the specified threshold number of levels.

13. The system of claim 9, the operations further comprising:
based on determining that each level node classification output is not aligned with a previous level node classification output based on determining at first level node classification is not aligned with a previous second level node classification, determining that a number of levels of nodes that are aligned is less than a specified threshold number of levels; and
based on determining that a confidence score is greater than a higher specified threshold, generating the final classification for the input data, the final classification comprising the previous second level node classification.

14. The system of claim 9, wherein the input data is at least one of an image, a document, text, video, or audio.

15. The system of claim 9, wherein the first machine learning model is a different type of machine learning model than the machine learning model corresponding to a next level node of the model tree classifier.

16. The system of claim 15, wherein the first machine learning model is a less processing-intense machine learning model and generates a less precise classification and the machine learning model corresponding to a next level node of the model tree classifier is a more processing-intense machine learning model and generates a more precise classification.

17. A non-transitory computer-readable medium comprising instructions stored thereon that are executable by at least one processor to cause a computing device to perform operations comprising:
receiving input data for classification by a model tree classifier comprising a machine learning model corresponding to each level in a hierarchy of nodes in the model tree classifier;
analyzing the input data using a first machine learning model corresponding to a root level node of the model tree classifier to generate a level node classification and a confidence score corresponding to the classification;
for each level in the hierarchy of nodes after the root level node in the model tree classifier:
determining a next level node of the model tree classifier based on a generated classification output of a previous level node; and
analyzing the input data to generate a level node classification output and a level node confidence score corresponding to the classification;
determining whether each level node classification output is aligned with a previous level node classification output;
based on determining that each level node classification output is aligned with a previous level node classification output, determining whether a confidence score corresponding to at least one level node classification output is greater than a specified threshold; and
generating a final classification for the input data based on determining that a confidence score corresponding to the at least one level node classification output is greater than the specified threshold, the final classification comprising the level node classification output of the last level node in the hierarchy of nodes in the model tree classifier.

18. The non-transitory computer-readable medium of claim 17, the operations further comprising:
based on determining that each level node classification output is not aligned with a previous level node classification output based on determining at first level node classification is not aligned with a previous second level node classification, generating the final classification for the input data based on determining that a confidence score corresponding to the at least one level node classification output is greater than the specified threshold, the final classification comprising the previous second level node classification.

19. The non-transitory computer-readable medium of claim 17, the operations further comprising:
not generating the final classification based on determining that there is no confidence score corresponding to a level node classification that is greater than the specified threshold.

20. The non-transitory computer-readable medium of claim 17, the operations further comprising:
determining that a number of levels of nodes that are aligned is less than a specified threshold number of levels; and
not generating the final classification based on the determination that the number of levels of nodes that are aligned is less than the specified threshold number of levels.
